(19) United States
(12) Patent Application Publication
(10) Pub. No.: US 2025/0015524 A1
(43) Pub. Date: Jan. 9, 2025

(54) HIGH-CONDUCTIVITY COMPOSITE CABLE, CABLE CONNECTOR THEREFOR AND METHOD FOR MANUFACTURING THEREOF

(71) Applicant: FLATVOX FZC LLC, Ajman (AE)

(72) Inventors: Dmitry Vladimirovich PETRENKO, Afipsky (RU); Mikhail GORDEN, Dubai (AE)

(21) Appl. No.: 18/218,186

(22) Filed: Jul. 5, 2023

(51) Int. Cl. H01R 12/77; H01B 7/08; H01B 13/00; H01R 24/58

(52) U.S. Cl. CPC H01R 12/777; H01B 7/0838; H01B 7/0869; H01B 13/0003; H01R 24/58; H01B 7/365

(57) ABSTRACT

The invention relates to a high-conductivity composite cable, a cable connector for the cable, as well as to a method for manufacturing the cable. The cable comprises a conductive layer comprising multiple busbars extending parallel to each other in one plane and separated from each other by a dielectric material. Each busbar is made of a homogeneous conductive material. First and second insulation layers are provided on the upper and bottom surface of the conductive layer, respectively. Each insulation layer is made of a polymer self-adhesive tape. A coating layer made of a paper or fabric self-adhesive tape is provided on at least one of the insulation layers. The cable further comprises a reinforcing relief structure on the coating layer(s) and multiple apertures each providing access to one of the busbars through the coating layer(s) and the insulation layer(s). The cable may transmit signals of different forms as accurately and quickly as possible.

### TECHNICAL FIELD

The present disclosure relates generally to the field of electric cables. In particular, the present disclosure relates to a high-conductivity composite cable, a cable connector for the cable, as well as to a method for manufacturing the cable.

### BACKGROUND

Many oblate-shaped cables are known in the prior art. This shape is the result of an attempt to achieve greater productivity in cable manufacturing, longer cable lifetime and, in some cases, greater cable compactness. However, nowhere is it said about the advantages associated with an increase in the accuracy of the transmission of electrical signals and impulses. This is because that the parameters of the cores of the oblate-shaped cables most often do not correspond to the correct distribution of magnetic fields caused by a change in currents in cable conductors, thereby causing the induction of an electromotive force that prevents the increase and decrease of the useful electric current both in the very thickness of the conductor and in the mutual influence of adjacent conductors. Furthermore, methods for manufacturing the oblate-shaped cables are usually highly sophisticated, and their execution requires large investments associated with expensive and complex production (usually extrusion-type) equipment. On top of that, these methods are energy-intensive and relatively slow.

RU 2080674 C1 discloses a method for manufacturing ribbon cables from single wires coated with a polymer material. According to this method, the wires are pulled through a volatile liquid capable of forming an adhesive layer when interacting with the polymer, glued together to form a cable at a certain pressure, and then subjected to drying. Said drying is performed on a support element, after which the cable is removed from the latter. The disadvantage of this method is as follows: its high energy consumption, slowness, and the need to perform multiple manufacturing steps associated with heating, polymerization and drying. Moreover, the structure of the cable consisting of the individual wires prevents the effective change in a useful electrical signal, which leads to a deterioration in the cable characteristics.

EP 0938099 A1 discloses a flat cable and method for its manufacture. The flat cable comprises a plurality of rectangular conductors embedded in parallel in an insulating resin layer. The insulating resin layer that is in contact with at least said rectangular conductors is an extruded coating layer made of a thermoplastic resin having a flexural modulus of 800 to 2400 MPa. The disadvantages of such a cable, as well as the method for its manufacture, are similar to those peculiar to the ribbon cables disclosed in RU 2080674 C1.

Thus, there is a need for a technical solution that can significantly speed up and reduce the cost of oblate-shaped cable manufacturing, as well as significantly increase the speed and accuracy of the transmission of electrical signals of complex shapes (e.g., electrical impulses) by the cable thus manufactured.

### SUMMARY

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide an oblate-shaped cable that may provide a high conductivity of electrical signals and pulses, as well as may be easily and quickly manufactured at a lower (compared to the prior art analogues) cost.

The objective above is achieved by the features of the independent claims in the appended claims. Further embodiments and examples are apparent from the dependent claims, the detailed description, and the accompanying drawings.

According to a first aspect, a high-conductivity composite cable is provided. The cable comprises a conductive layer comprising a set of busbars extending parallel to each other in one plane and separated from each other by a dielectric material. Each busbar of the set of busbars is made of a homogeneous conductive material. The cable further comprises a first insulation layer provided on the upper surface of the conductive layer and a second insulation layer provided on the bottom surface of the conductive layer. Each of the first insulation layer and the second insulation layer is made of a polymer self-adhesive tape. The cable further comprises a first coating layer covering the first insulation layer. The first coating layer is made of a paper or fabric self-adhesive tape. The cable further comprises a reinforcing relief structure provided on the first coating layer, as well as a set of apertures each providing access to one busbar of the set of busbars through the first coating layer and the first insulation layer. The cable thus configured may transmit signals of simple and complex forms as accurately and quickly as possible. This may make the cable applicable in different technical fields (e.g., in the audio industry, in the field of electrical measurements and detection, as well as in the fields of computer and other communications).

In one exemplary embodiment of the first aspect, each busbar of the set of busbars has an equal width, and the set of busbars has an inter-busbar spacing ranging from 0.5 to 10 widths. Such a spacing between the busbars may additionally reduce their mutual effect on each other due to the intersecting magnetic-field lines that occur when a current flows in each of the busbars.

In one exemplary embodiment of the first aspect, each busbar of the set of busbars has a width-to-thickness ratio ranging from 100 to 3000. With such busbars, the cable may be more compact in size.

In one exemplary embodiment of the first aspect, the cable further comprises an armour layer provided between the first coating layer and the first insulation layer. The armour layer may increase the flexural strength of the cable by distributing a bending force (if present) along the length of the cable and, consequently, preventing sharp bends and kinks.

In one exemplary embodiment of the first aspect, the armour layer is configured as a mesh structure having a flexural modulus ranging from 700 to 2600 MPa. This mesh structure may provide the best flexural strength of the cable.

In one exemplary embodiment of the first aspect, the cable further comprises an information-carrying layer provided on the first coating layer. The information-carrying layer may inform a user about different parameters of the cable (its label, manufacturer, maximum permissible current, etc.), as well as server for decorative purposes.

In one exemplary embodiment of the first aspect, the cable further comprises a second coating layer covering the second insulation layer. The second coating layer is made of a paper or fabric self-adhesive tape and provided with a reinforcing relief structure. This embodiment may be used when it is required to strengthen the structure of the cable. Similar to the reinforcing relief structure on the first coating layer, the reinforcing relief structure on the second coating layer may act as a means of compensating and reducing the sharp and excessive breaking force that may be applied to the cable during its operation.

In one exemplary embodiment of the first aspect, the cable further comprises an information-carrying layer provided on the second coating layer. The additional information-carrying layer may also inform a user about different parameters of the cable (its label, manufacturer, maximum permissible current, etc.), as well as server for decorative purposes.

In one exemplary embodiment of the first aspect, the cable further comprises a set of apertures each providing access to one busbar of the set of busbars through the second coating layer and the second insulation layer. This embodiment makes it possible to access the busbars from either side, which may be useful in some use scenarios (e.g., it may be more convenient to solder connecting wires to the busbars alternately from above and below).

According to a second aspect, a cable connector for the high-conductivity cable according to the first aspect is provided. The cable connector comprises a hollow cylindrical body provided with an opening cover, a set of connection elements, and an input jack. The set of connection elements is arranged in the body such that each connection element of the set of connection elements is accessible through the opening cover. Each connection element of the set of connection elements is configured to be coupled to one busbar of the set of busbars of the cable through corresponding one of the set of apertures. The input jack is provided at one end of the body and coupled to the set of connection elements. By using the cable connector thus configured, it is possible to plug the cable into a port or an interface of an electronic system (e.g., audio system) more efficiently.

According to a third aspect, a method for manufacturing the high-conductivity composite cable according to the first aspect is provided. The method starts with the step of providing each of the conductive layer, the first insulation layer, the second insulation layer and the first coating layer in roll form. Then, the method proceeds to the step of unrolling and simultaneously feeding each of the conductive layer, the first insulation layer, the second insulation layer and the coating layer to a (cold) roller press. The roller press comprises two rollers, at least one of which is provided with relief notches configured to form the reinforcing relief structure on the first coating layer of the cable. After that, the method goes on to the step of forming the set of apertures each extending through the first coating layer and the first insulation layer to one busbar of the set of busbars. By using this method, it is possible to manufacture the cable easily and quickly at a lower (compared to the prior art analogues) cost.

In one exemplary embodiment of the third aspect, the set of apertures is formed by using a laser. By doing so, it is possible to obtain the apertures of a proper size and shape with high accuracy.

In one exemplary embodiment of the third aspect, the method further comprises, before the step of feeding, an additional step, in which a contact adhesive is applied to each of the first insulation layer, the second insulation layer and the first coating layer. This may provide better attachment of the cable layers to each other.

Other features and advantages of the present disclosure will be apparent upon reading the following detailed description and reviewing the accompanying drawings.

### BRIEF DESCRIPTION OF THE DRAWINGS

The present disclosure is explained below with reference to the accompanying drawings in which:

FIG. 1 shows a schematic cross-sectional view of a high-conductivity composite cable in accordance with one exemplary embodiment;

FIG. 2 schematically shows a method for manufacturing the cable of FIG. 1 in accordance with one exemplary embodiment;

FIG. 3 explains how a set of apertures may formed in the cable of FIG. 1 by using a laser during the method of FIG. 2;

FIG. 4 shows a reinforcing relief structure that may be formed in the cable of FIG. 1; and

FIG. 5 shows a schematic isometric view of a cable connector for the cable of FIG. 1 in accordance with one exemplary embodiment.

### DETAILED DESCRIPTION

Various embodiments of the present disclosure are further described in more detail with reference to the accompanying drawings. However, the present disclosure may be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatuses and method disclosed herein may be implemented in practice by using any numbers of the embodiments provided herein. Furthermore, it should be understood that any embodiment of the present disclosure may be implemented using one or more of the features presented in the appended claims.

The word “exemplary” is used herein in the meaning of “used as an illustration”. Unless otherwise stated, any embodiment described herein as “exemplary” should not be construed as preferable or having an advantage over other embodiments.

Any positioning terminology, such as “left”, “right”, “top”, “bottom”, “above” “below”, “upper”, “lower”, “horizontal”, “vertical”, “front”, “rear”, etc., may be used herein for convenience to describe one element's or feature's relationship to one or more other elements or features in accordance with the figures. It should be apparent that the positioning terminology is intended to encompass different orientations of the apparatus disclosed herein, in addition to the orientation(s) depicted in the figures. As an example, if one imaginatively rotates the apparatus in the figures 90 degrees clockwise, elements or features described as “left” and “right” relative to other elements or features would then be oriented, respectively, “above” and “below” the other elements or features. Therefore, the positioning terminology used herein should not be construed as any limitation of the invention.

Although the numerative terminology, such as “first”, “second”, etc., may be used herein to describe various embodiments, elements or features, these embodiments, elements or features should not be limited by this numerative terminology. This numerative terminology is used herein only to distinguish one embodiment, element or feature from another embodiment, element or feature. For example, a first insulation layer may be called a second insulation layer, and vice versa, without departing from the teachings of the present disclosure.

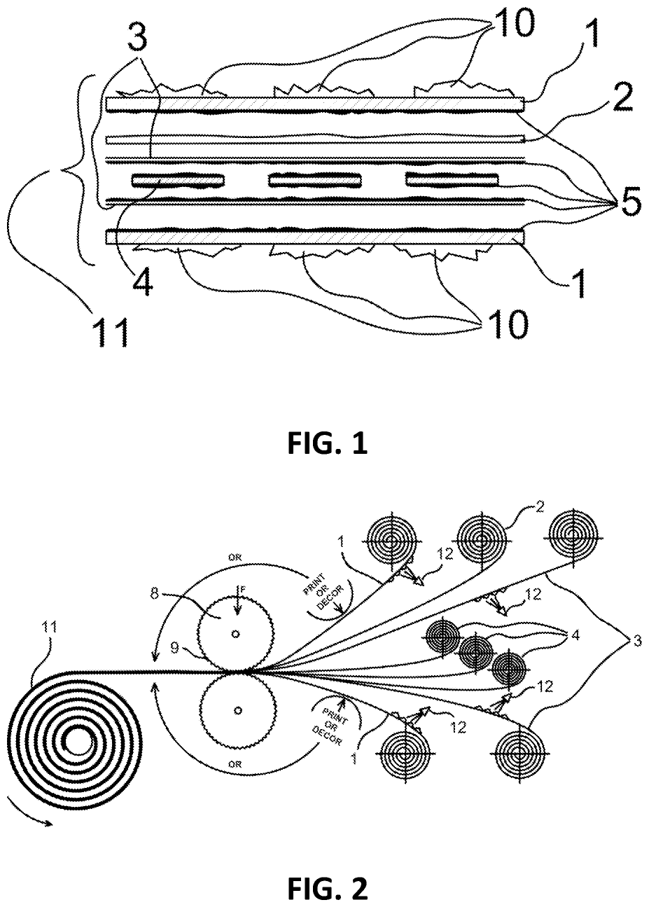

FIG. 1 shows a schematic cross-sectional view of a high-conductivity composite cable 11 in accordance with one exemplary embodiment. The cable 11 comprises a (inner) conductive layer comprising a set of busbars 4 extending parallel to each other in one (horizontal) plane and separated from each other by a dielectric material. Each solid busbar 4 is used as a carrier of electric current and as thin as possible, but at the same time as wide as possible. In practice, the width-to-thickness of each busbar 4 varies from 100 to 3000. Each busbar must be made of a homogeneous electrically conductive material, such as copper, gold, silver, aluminum, graphene, carbon, etc.

The busbar 4 should not have any other metal coatings, should not consist of many individual conductors. The requirement for the arrangement of the adjacent busbars 4 in the conductive layer is such that their spacing should be as large as possible. Preferably, the inter-busbar spacing is from 0.5 to 10 times the width of each of the busbars 4 and is due to practical considerations. This inter-busbar spacing may reduce the mutual effect of the busbars 4 on each other due to the intersecting magnetic-field lines that occur when the current flows in each of the busbars 4. Since the decrease in the intensity of the magnetic-field lines at a distance from the busbar 4 is non-linear, but progressive, the inter-busbar spacing may be selected according to the principle of reasonable sufficiency of the level of mutual penetration of the parasitic effect of magnetic fields. Preferably, the optimal inter-busbar spacing is the same as at least one width of each busbar 4.

In the case of using a conventional electric wire from other manufacturers, it turned out that with the increase and decrease in the electric current, its carriers—electrons—create ring magnetic fluxes. These fluxes are summed up in a circular conductor, which leads to the formation of a tubular magnetic field located along the axis of the conductor and partially located inside it. Thus, the electromotive force that the tubular magnetic field induces leads to the stratification of the electric current and its displacement onto the surface of the conductor on the one hand, and on the other hand to its concentration in the central part of the conductor. Moreover, the direction of such currents is opposite.

The occurrence of such a parasitic magnetic field distribution and the parasitic currents caused by it impede the rate of change of a useful electrical signal in such a conductor. Accordingly, when trying to quickly build up a short electrical impulse, such a conductor is leveled by self-induction currents. As a result, when using such a conductor to transmit an audio signal, some of the useful information in the audio signal can be lost (first of all, fast changes in values are “rounded off”, pulses are “eaten”, and the frequency at which such a conductor can effectively transmit decreases). That is, the complex forms of an electrical signal are greatly simplified and averaged. This is especially aggravated if such round conductors are located close to each other. Furthermore, various coatings of conductors, for example, silver-plated, tinning, etc., lead to the fact that the current displaced to the periphery of the conductor under the action of the skin effect flows through the region of increased transient resistance from one metal to another, which further reduces the signal transmission efficiency.

To avoid the above-indicated disadvantages, the cable 11 has been proposed, which comprises the following layered structure. As noted earlier, the (inner) conductive layer comprising the set of busbars 4 separated by the dielectric material is covered on both (top and bottom) sides with two insulation layers 3 each made of a polymer self-adhesive tape (e.g., Scotch tape). The next layer is an amour 2: This layer may be configured as a mesh structure having a flexural modulus ranging from 700 to 2600 MPa, which may be used to distribute the bending force along the length of the cable 11, preventing sharp bends and kinks. The following coating layers 1 cover, mainly on both sides, the above-described internal structure and are external. Such coating layers 1 are made of a paper or fabric self-adhesive tape. On the front side of the cable 11, decorative or information-carrying layers 10 (e.g., image) may be applied.

It should be noted that the sequence of the cable layers, as well as their number in the cable 11, may vary, if required and depending on particular applications. In one embodiment, the cable 11 may comprise one only coating layer 1 (e.g., on the upper insulation layer 3), and the busbars 4 may be glued to it—this embodiment may be useful when it is necessary, for example, to glue the cable 11 to a certain device, piece of furniture, or wall with a sticky adhesive layer 5. In another embodiment, two coating layers 1 facing each other with their adhesive compositions are possible, where the busbars 4 are enclosed between the coating layers 1—in this embodiment, the information-carrying layers 10 may be provided on both coating layers 1.

As for the armour layer 2, it may be omitted if the parameters of the flexural modulus of the other layers correspond to predefined requirements.

FIG. 2 schematically shows a method for manufacturing the cable 11 in accordance with one exemplary embodiment. Actually, the method is a process of pressing in a mechanized way, which is performed as follows: rolls of self-adhesive materials are strengthened in pressing equipment, so that in the process of unrolling and feeding them to pressure rollers 8 of a roller press, the sequence of the layers of the resulting cable 11 is observed (see FIG. 1), together with the precise positioning of the laying of the busbars 4 and the alignment of the edges of the self-adhesive tapes. The pressing process is characterized in that at least one of the pressure rollers 8 is provided or coated with relief notches, which are required to create a reinforcing relief structure in the cable 11 (see FIG. 4). The reinforcing relief structure is used as a means of compensating and reducing the sharp and excessive breaking force applied to the cable 11 during its operation.

In one embodiment, during the method, the adhesive layer may be applied on each self-adhesive tape not in advance, but directly in the process of unrolling the tapes before said pressing. For this purpose, the equipment may be provided with nozzles for applying the contact adhesive layer 12.

It is also possible to apply different informational or decorative inscriptions and images on the front surface of the layers 1 either before or after the tapes pass through the rollers 8 of the roller press.

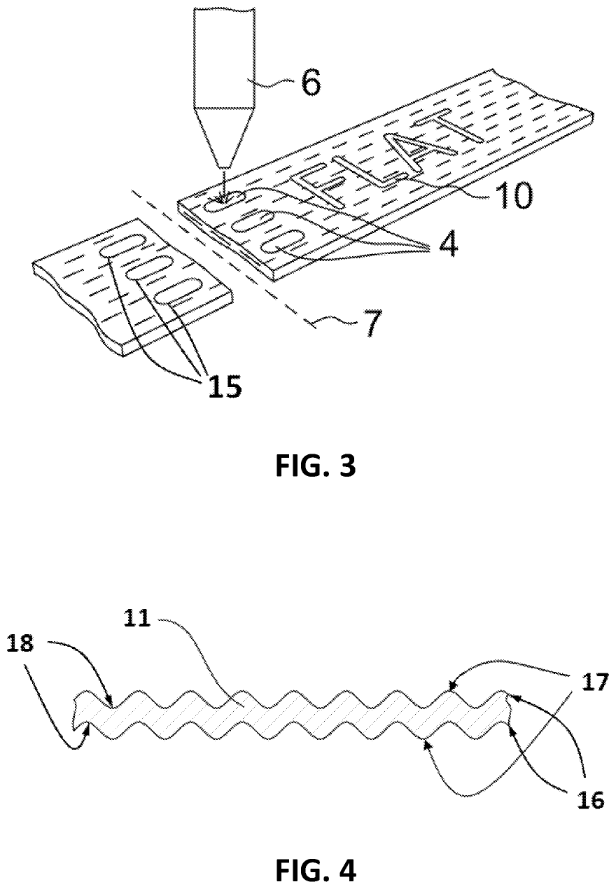

FIG. 3 explains how a set of apertures may formed in the cable 11 by using a laser 6 during the method of FIG. 2. These apertures are used to provide access to the busbars 4 of the cable 11 (i.e., to couple (e.g., solder) them to a certain cable connector). To do this, the cable 11 is unrolled to a desired length to obtain a resulting cable of a finite length, cut off along a cut line 7. Either before or after the cutting procedure, in places close to the cut line 7, the surface layers (i.e., the coating layer(s) 1 and the insulation layers 3) of the cable 11 are burned with the laser 6 up to the busbars 4. In this way, the apertures are burned through which bare metal is visible, ready for connection by soldering.

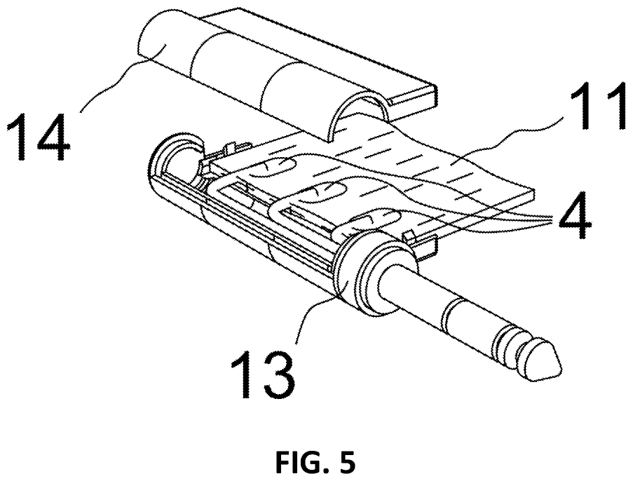

FIG. 5 shows a schematic isometric view of a cable connector for the cable 11 in accordance with one exemplary embodiment. The cable connector comprises a hollow cylindrical body 13 provided with an opening cover 14, a set of connection elements, and an input jack. The cover 14 may be attached to the body 13 in any detachable or one-piece (for example, by means of glue) method. The set of connection elements is arranged in the body 13 such that each connection element of the set of connection elements is accessible through the opening cover. Each connection element of the set of connection elements is configured to be coupled (e.g., soldered) to one of the busbars 4 of the cable 11 through corresponding one of the apertures. The input jack is provided at one end of the body 13 and coupled to the set of connection elements. The connector of this form allows one to freely connect the cable 11 to standardized terminals for connecting various devices and equipment. The connection elements may be of any shape and configuration (e.g., may be in the form of wires, tracks, etc.). The connector may comply with the following connector standards: RCA, XLR, SPEACON, USB, JACK, mini-JACK, etc.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. A high-conductivity composite cable comprising:
a conductive layer comprising a set of busbars extending parallel to each other in one plane and separated from each other by a dielectric material, each busbar of the set of busbars being made of a homogeneous conductive material, the conductive layer having an upper surface and a bottom surface;
a first insulation layer provided on the upper surface of the conductive layer;
a second insulation layer provided on the bottom surface of the conductive layer, each of the first insulation layer and the second insulation layer being made of a polymer self-adhesive tape;
a first coating layer covering the first insulation layer, the first coating layer being made of a paper or fabric self-adhesive tape;
a reinforcing relief structure provided on the first coating layer; and
a set of apertures each providing access to one busbar of the set of busbars through the first coating layer and the first insulation layer.

2. The cable of claim 1, wherein each busbar of the set of busbars has an equal width, and wherein the set of busbars has an inter-busbar spacing ranging from 0.5 to 10 widths.

3. The cable of claim 1, wherein each busbar of the set of busbars has a width-to-thickness ratio ranging from 100 to 3000.

4. The cable of claim 1, further comprising an armour layer provided between the first coating layer and the first insulation layer.

5. The cable of claim 4, wherein the armour layer is configured as a mesh structure having a flexural modulus ranging from 700 to 2600 MPa.

6. The cable of claim 1, further comprising an information-carrying layer provided on the first coating layer.

7. The cable of claim 1, further comprising:
a second coating layer covering the second insulation layer, the second coating layer being made of a paper or fabric self-adhesive tape; and
a reinforcing relief structure provided on the second coating layer.

8. The cable of claim 7, further comprising an information-carrying layer provided on the second coating layer.

9. The cable of claim 7, further comprising a set of apertures each providing access to one busbar of the set of busbars through the second coating layer and the second insulation layer.

10.-13. (canceled)
